(19) United States
(12) Patent Application Publication
(10) Pub. No.: US 2024/0318690 A1
(43) Pub. Date: Sep. 26, 2024

(54) COMPONENT FOR A ROLLING BEARING AND CORRESPONDING METHOD FOR PRODUCING THE COMPONENT

(71) Applicant: AKTIEBOLAGET SKF, GOTEBORG (SE)

(72) Inventor: Mohamed SHERIF, Hilversum (NL)

(21) Appl. No.: 18/579,559

(22) PCT Filed: Jul. 23, 2021
(86) PCT No.: PCT/EP2021/070698

§ 371 Date: Jan. 16, 2024

(51) Int. Cl. F16C 33/62; C21D 1/20; C21D 1/26; C21D 6/00; C21D 9/40; C22C 38/00; C22C 38/44; C22C 38/52; C23C 8/26; F16C 33/64

(52) U.S. Cl. CPC F16C 33/62; C21D 1/20; C21D 1/26; C21D 6/004; C21D 9/40; C22C 38/001; C22C 38/44; C22C 38/52; C23C 8/26; F16C 33/64; F16C 2204/72; F16C 2223/14

(57) ABSTRACT

A method of manufacturing a component of a rolling-element bearing includes: providing a steel body having a carbon content of less than 0.3 weight-%, a chromium content of greater than 8.0 weight-%, and a nitrogen content of less than 0.1 weight-%; high-temperature solution nitriding the steel body; after the high-temperature solution nitriding, performing an intermediate tempering process to reduce a size of austenite grains in the steel body; and after the intermediate tempering process, performing a reaustenitizing annealing. Also the component made by the method.

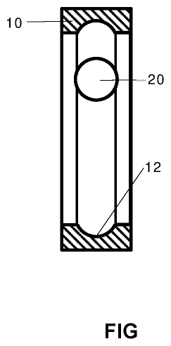

The invention relates to a component of a rolling-element bearing assembly and a corresponding method for the manufacturing of the component.

From DE 197 07 033 A1 it is known for the manufacture rolling-element bearings with a high performance capability, using case-hardened stainless steels that are superior to conventional martensite-based stainless steels with respect to corrosion resistance, roller fatigue strength, and wear resistance, and also have a high core toughness, to produce at least one representative from the group inner ring, outer ring, and rolling elements (rolling bodies) made from an alloy steel, that is essentially comprised of less than 0.5 weight-% C, 8.0 to 20.0 weight-% Cr, 0.1 to 1.5 weight-% Mn, 0.1 to 2.0 weight-% Si, and the rest as Fe and incidental impurity elements, in which the bearing also includes a surface layer that has been generated by nitriding or carbonitriding at a temperature below Ac1, subsequent heating to a temperature of 900 to 1200° C., hardening, a low-temperature treatment (below 0° C.), and tempering. Here in particular from the standpoint of productivity, nitriding in the austenite range (1100 to 1250° C.) was not preferred since longer nitriding in the austenite range (1100 to 1250° C.) causes a growth and a coarsening of the austenite grains, whereby the strength of the steel is reduced. High-temperature nitriding at 1150° C. for 4 h was used only for comparative samples.

From the book by V. G. Gavriljuk et al., “High nitrogen steels: structure, properties, manufacture, applications,” Springer-Verlag, 1999, pages 308 to 311, it is known to use a steel with a chromium content of 13 to 17 mass-percentage for a martensitic hardening, to solution-nitride this steel at a temperature of 1150° C. for 24 h in order to then subject it to an intermediate soft tempering for the purpose of austenite grain-size reduction, followed by a second hardening at a temperature lower than or equal to the solution nitriding temperature of 1150° C., whereupon a deep cooling at −80° C. follows for 1 h and is finally followed by three temperings at 450° C. for 1 h.

From the article by H. Berns, “Stainless steels suited for solution nitriding,” Materialwissenschaft und Werkstofftechnik 33 (2002), pages 5 to 11, an entire series of steels suited for solution nitriding are known. Here for the martensitic application, two steels are also described that come close to CRONIDUR 30 known in the rolling-element bearing industry.

From the article by R. Mohammadzadeh et al., “Grain refinement of a nickel and manganese free austenitic stainless steel produced by pressurized solution nitriding,” Materials Characterization 93 (2014), pages 119 to 128, a heat-treatment method is described in which after a gas-pressure solution nitriding of the steel, followed by a water quenching and a subsequent austenite-grain refining, which in turn is composed of a decomposing isothermal heating followed by a water quenching followed by a reaustenitizing heating and a subsequent water quenching. Here a temperature of 1200° C., increasing pressures up to 2.5 bar, and durations of 1 to 18 h are specified for the gas-pressure nitriding. For the decomposing heating, it was finally set to 700° C. for a duration of 4 h. Finally, the reaustenitizing heating was carried out at 1200° C. and 0.5 h. The steel used as the basis here for the nitriding comprised, in addition to iron, in weight-percent: ≤0.002 carbon, 22.753 chromium, 0.054 nickel, 0.1 manganese, 2.42 molybdenum, 0.052 silicon, ≤0.5 copper, 0.05 aluminum, 0.03 nitrogen, 0.01 phosphorus, and 0.007 sulfur.

An object of the present invention is based on, among other things, providing an improved component of a rolling-element bearing, and providing a corresponding method for the manufacturing of the improved component.

The object is achieved by the subject matter of patent claims 1 and 7. Advantageous designs are described in patent claims 2 to 6.

With the inventive solution, it is now possible to use the advantages of high-temperature solution nitriding, for example, with respect to the achievable microstructures, with simultaneous avoiding of the disadvantages thereof described in DE 197 07 033 A1, by using an intermediate tempering after the high-temperature nitriding for austenite grain-size reduction, and using a reaustenitizing annealing after the intermediate tempering. According to a further recognition of this invention, however, the disadvantages, not recognized in DE 197 07 033 A1, of low-temperature surface hardening, such as chromium nitride formation due to stretching-induced martensite, for example, due to previous turning, milling, cold-rolling, bending, etc., but also of conventional nitriding, such as chromium nitride formation in the surface, are particularly advantageously avoided. Thus ultimately not only the high edge layer hardnesses needed by rolling-element bearings but rather overall advantageously also a low fatigue vulnerability and thus a long service life are achievable. Due to the possible low carbon but also nitrogen content of the output steel, the comparative cost-effectiveness of such stainless steels is ultimately advantageously maintained. An economical, corrosion-resistant component of a rolling-element bearing, which component also has a long service life, is thus advantageously provided.

A large number of experiments were carried out with different temperatures, durations, and steel compositions in various combinations. Here those advantageous experiment results, and in particular value ranges that have proved particularly advantageous, characterize the claimed temperature and time ranges. When temperature and time ranges are combined, the combination of values at the lower or upper end of a temperature range with values at the lower or upper end of the time range generally results in a less favorable overall situation than combinations of both ranges in their middle or the combination of values at different ends of the two ranges.

The Figure shows, as one embodiment, a longitudinal section through a raceway element of a rolling-element bearing with a raceway 12 for rolling elements formed as balls 20 for rolling thereon, in which by way of example only one ball 20 is shown. The balls 20 can be disposed in a not-shown cage in which the ball bearing is finally completed by an also-not-shown ball-bearing inner ring. Other exemplary embodiments of such components are rings and rollers of rolling-element bearings, comprising, tapered, cylindrical, and spherical roller bearings, but also of needle roller bearings in single-row or multi-row formation as well as combinations, etc.

Here the ball-bearing outer ring 10 assumes a steel tube made of a steel with 13 weight-% Cr, 3 weight-% Co, 2 weight-% Ni, 1 weight-% Mo, and 0.07 weight-% N. Here the steel composition is ultimately determined by choosing the economically optimal, that is, most cost-effective, steel composition with sufficient functionality for the respective application. Thus, for example, higher proportions of C, Cr, Mn, Mo, Ni, N, and the like are beneficial for the hardening and corrosion resistances thus achievable, as well as for the durations required in the progress of the manufacturing process, but also make the steel more expensive.

Depending on the application, in other embodiments steels are therefore certainly also used that are not free from an intended carbon addition, but rather they have a carbon content up to 0.25, indeed even upwards to 0.3 weight-%. Depending on the application, chromium contents of 8.0, 9.0, or even 11.0 weight-% are sufficient and do not have to be 17, 22, or even 26 weight-%. Furthermore, the steel can also be free from an intended nitrogen addition, or, for example, for shorter solution nitriding durations, even have a nitrogen content of less than 0.1 weight-%.

The basic shape of the ball-bearing outer ring 10 is ultimately generated by cutting-to-length from the steel tube and corresponding turning. As explained below, this blank is then high-temperature solution-nitrided and heat-treated. In other embodiments, the blank, for example, is consolidated from a steel powder, heat, cold, and/or otherwise soft-processed.

The high-temperature solution nitriding is carried out isothermally at a temperature of 1125° C. for 11 h. After the solution nitriding, the blank has in its edge regions a nitrogen content of approximately 0.5 weight-%. In turn depending on the application, in which the geometry of the blank can also play a role, the high-temperature solution nitriding is carried out at a temperature of 1050° C. to 1190° C., in particular 1100° C. to 1150° C., for a few to several hours, in particular 1 h to 24 h, in particular up to 12 h. Following the high-temperature solution nitriding, the solution-nitrided blank is quenched in an oil bath. In other embodiments a quenching occurs in the salt bath or with water.

Afterwards, for the austenite grain-size reduction, the blank is subjected to an intermediate tempering that is carried out isothermally at a temperature of 850° C. for 3.5 h. In turn in a manner depending on the application, in other embodiments the intermediate tempering takes place at a temperature of 600° C. to 1000° C., in particular 700° C. to 900° C., for few hours, in particular 1 h to 6 h, in particular 2 h to 4 h. Afterwards it is in turn quenched.

A reaustenitizing annealing then follows this, which is carried out isothermally at a temperature of 1125° C. for a half hour. In turn in a manner depending on the application, in other embodiments the annealing is also carried out at a temperature of 1000° C. to 1275° C., in particular 1050° C. to 1250° C., in particular to a temperature less than or equal to that in the high-temperature solution nitriding, for a plurality of minutes up to few hours, in particular for 0.1 h to 2.5 h, in particular 0.2 h to 1.5 h.

Afterwards the blank is quenched toward a low-temperature treatment that takes place at −80° C. for 4 h. In turn in a manner depending on application, in other embodiments the low-temperature treatment takes place at a temperature below 0° C., in particular from −40° C. to −196° C. for a number of minutes up to a plurality of hours, in particular for 0.3 h to 8 h, in particular 1 h to 6 h. Afterwards the blank is martensitically hardened. Finally, the blank is still isothermally tempered at a temperature of 250° C. for 4 h. In turn depending on the application, in other embodiments the tempering takes place at a temperature of 150° C. to 450° C., in particular up to 350° C., for a half hour up to a plurality of hours, in particular 1 h to 8 h, in particular 2 h to 6 h. Instead of the tempering in one stretch, the tempering can also be repeated cyclically, in particular with intermediate low-temperature treatment, in which the time specifications mentioned above then relate to the sum of the repetitions. Finally, the hardened blank is finished by a hard processing, in particular comprising a grinding, honing, and/or superfinishing, into the ball-bearing outer ring 10.

Here a component manufactured in this manner is advantageously usable in machines of the metal-producing and metal-processing industry, but also the paper industry, in pumps and (air) compressors, solutions of the aerospace industry, the food and luxury food industry, but also in electric vehicles and sports bicycles, in particular when corrosive media occur in this use that are possibly even used as bearing lubricant and/or coolant.

1. A component of a rolling-element bearing produced by a method comprising:
providing a steel body having a carbon content of less than 0.3 weight-%, chromium content of greater than 8.0 weight-%, and a nitrogen content of less than 0.1 weight-%,
high-temperature solution nitriding the steel body,
after the high-temperature solution nitriding, performing an intermediate tempering process to reduce a size of austenite grains in the steel body, and
after the intermediate tempering process, performing a reaustenitizing annealing.

2. The component according to claim 1,
wherein:
the high-temperature solution nitriding is carried out isothermally at a temperature of 1050° C. to 1190° C., for 1 h to 24 h,
wherein the intermediate tempering is carried out isothermally at a temperature of 600° C. to 1000° C., for 1 h to 6 h, and
wherein the reaustenitizing annealing is carried out isothermally at a temperature of 1000° C. to 1275° C. for 0.1 h to 2.5 h.

3. The component according to claim 1, wherein;
following the reaustenitizing annealing, an isothermal low-temperature treatment is carried out at a temperature below 0° C., for 0.3 h to 8 h, and
after the low-temperature treatment, an isothermal tempering is carried out at least once at a temperature of 150° C. to 450° C., for a total time of 1 h to 8 h.

4. The component according to claim 3, including performing a quenching between the high-temperature solution nitriding and the intermediate tempering, and between intermediate tempering and the reaustenitizing annealing.

5. The component according to claim 4, wherein providing the steel body comprises consolidating the steel body from a steel powder; and heat, cold, and/or soft processing the consolidated steel body.

6. The component according to claim 4, wherein the carbon content of the steel body is less than 0.25 weight-%, the chromium content is greater than 9.0 weight-%, the steel body is free from an intended nitrogen addition, the steel body comprises nickel, molybdenum, and/or manganese, and/or the steel body has a nitrogen content in an edge layer after the solution nitriding is greater than 0.1 weight-%.

7. (canceled)

8. The component according to claim 1,
wherein:
the high-temperature solution nitriding is carried out isothermally at a temperature of 1100° C. to 1150° C. for up to 12 h,
wherein the intermediate tempering is carried out isothermally at a temperature of 700° C. to 900° C. for 2 h to 4 h, and
wherein the reaustenitizing annealing is carried out isothermally at a temperature of 1050° C. to 1250° C. for 0.2 h to 1.5 h.

9. The component according to claim 8, wherein:
following the reaustenitizing annealing, an isothermal low-temperature treatment is carried out at a temperature from −40° C. to −196° C., for 1 h to 6 h, and after the low-temperature treatment, an isothermal tempering is carried out at least once at a temperature of 150° C. to 350° C. for a total time of 2 h to 6 h.

10. The component according to claim 1,
wherein the reaustenitizing annealing is carried out at a temperature less than or equal to a temperature of the high-temperature solution nitriding.

11. The component according to claim 4,
wherein:
the carbon content of the steel body is less than 0.25 weight-%,
the chromium content is greater than 11.0 weight-%,
the steel body is free from an intended nitrogen addition,
the steel body includes nickel, molybdenum, and/or manganese, and/or
the steel body has a nitrogen content in an edge layer after the solution nitriding greater than 0.3 weight-%.

12. A method of manufacturing a component of a rolling-element bearing comprising:
providing a steel body having a carbon content of less than 0.3 weight-%, a chromium content of greater than 8.0 weight-%, and a nitrogen content of less than 0.1 weight-%,
high-temperature solution nitriding the steel body,
after the high-temperature solution nitriding, performing an intermediate tempering process to reduce a size of austenite grains in the steel body, and
after the intermediate tempering process, performing a reaustenitizing annealing.

13. The method of claim 12,
wherein:
the high-temperature solution nitriding is carried out isothermally at a temperature of 1050° C. to 1190° C. for 1 h to 24 h,
wherein the intermediate tempering is carried out isothermally at a temperature of 600° C. to 1000° C. for 1 h to 6 h, and
wherein the reaustenitizing annealing is carried out isothermally at a temperature of 1000° C. to 1275° C.

14. The method according to claim 12,
wherein:
the high-temperature solution nitriding is carried out isothermally at a temperature of 1100° C. to 1150° C. for up to 12 h,
wherein the intermediate tempering is carried out isothermally at a temperature of 700° C. to 900° C. for 2 h to 4 h, and
wherein the reaustenitizing annealing is carried out isothermally at a temperature of 1050° C. to 1250° C. for 0.2 h to 1.5 h.

15. The method according to claim 12,
wherein the reaustenitizing annealing is carried out at a temperature less than or equal to a temperature of the high-temperature solution nitriding.

16. The method according to claim 12, wherein:
following the reaustenitizing annealing, an isothermal low-temperature treatment is carried out at a temperature from −40° C. to −196° C. for 0.3 h to 8 h, and
after the low-temperature treatment, an isothermal tempering is carried out at least once at a temperature of 150° C. to 450° C. for a total time of 1 h to 8 h.

17. The method according to claim 12, wherein:
following the reaustenitizing annealing, an isothermal low-temperature treatment is carried out at a temperature from −40° C. to −196° C. for 1 h to 6 h, and after the low-temperature treatment, an isothermal tempering is carried out at least once at a temperature of 150° C. to 350° C. for a total time of 2 h to 6 h.

18. The method according to claim 3,
including performing a quenching between the high-temperature solution nitriding and the intermediate tempering and between intermediate tempering and the reaustenitizing annealing.

19. The method according to claim 12,
wherein:
the high-temperature solution nitriding is carried out isothermally at a temperature of 1100° C. to 1150° C. for up to 12 h,
wherein the intermediate tempering is carried out isothermally at a temperature of 700° C. to 900° C. for 2 h to 4 h,
wherein the reaustenitizing annealing is carried out isothermally at a temperature of 1050° C. to 1250° C. for 0.2 h to 1.5 h,
wherein following the reaustenitizing annealing, an isothermal low-temperature treatment is carried out at a temperature from −40° C. to −196° C. for 1 h to 6 h, and
after the low-temperature treatment, an isothermal tempering is carried out at least once at a temperature of 150° C. to 350° C. for a total time of 2 h to 6 h, and
the method further including performing a quenching between the high-temperature solution nitriding and the intermediate tempering and between intermediate tempering and the reaustenitizing annealing.

20. A component formed by the method of claim 12.
